(19) United States
(12) Patent Application Publication
(10) Pub. No.: US 2002/0131326 A1
(43) Pub. Date: Sep. 19, 2002

(54) Pressure relief system for mixing tanks, especially container mixers for powdered, grit-like and/or granular materials

(76) Inventors: Andre Greiling, Borken (DE); Hans-Joachim Bornemann, Vellmar (DE)

Correspondence Address: McGLEW AND TUTTLE, P.C., SCARBOROUGH STATION, SCARBOROUGH, NY, 10510-0827, US

(21) Appl. No.: 10/028,110

(22) Filed: Dec. 24, 2001

(30) Foreign Application Priority Data
Jan. 25, 2001 (DE) 101 03 260.9

(51) Int. Cl. B01F 9/08

(52) U.S. Cl. 366/200

(57) ABSTRACT

A pressure relief system is provided for mixing tanks that are under overpressure at least temporarily, especially cylindrical container mixers for powdered, grit-like and/or granular materials. The mixing tank is pivotable around a preferably horizontal pivoting axis into a mixing position in which the materials are brought together with a mixing tool and wherein at least the discharge area and/or the closing flap (8) of the mixing tank are located outside the bulk of material. A hole of opening (20), which is sealed with a disk and/or shaft (12) via the intermediary of a membrane (15) with an elastic sealing lip (16), is provided in the discharge area and/or within the closing flap (8) for pressure relief during the mixing operation.

### BACKGROUND OF THE INVENTION

A mixer for such materials, in which a two-part mixing tank is mounted pivotably around a horizontal axis on a stand, has been known from WO 98/37954 A1. To feed in and remove the material to be mixed and the mixed material, the mixing tank is brought into a vertical position and the lower part of the container, which is designed as a replaceable container, is separated from the upper part of the container. The lower part of the container has a conical discharge area and a lower closing flap pivotable around a central axis of rotation. The mixing tank is pivoted for the mixing operation to the extent that its longitudinal axis has a slope of about 45°, the closing flap being arranged at the highest point. Designing the closing flap as a blocking filter, e.g., one made of sintered material, in order to make possible ventilation during the mixing operation, also belongs to the state of the art in such a container mixer. It was found that such blocking filters made of sintered material are easily clogged by dust particles and that these blocking filters must be subsequently cleaned or even replaced in a complicated manner.

Opening a valve after the mixing operation when the mixing tank is again in the vertical position for pressure relief prior to the opening of the container also belongs to the state of the art. This valve is now located in the upper position in the vicinity of the mixing tool. Pressure relief by means of this valve is not possible during the mixing operation. This is because it would immediately become clogged with the materials to be mixed.

### SUMMARY AND OBJECTS OF THE INVENTION

The basic object of the present invention is to propose an effective pressure relief system which is effective during the mixing operation and does not tend to become clogged or can be cleaned in a simple manner.

According to the invention, a pressure relief system is provided for the mixing tanks that are under overpressure at least temporarily, especially cylindrical container mixers for powdered, grit-like and/or granular materials. The mixing tank is pivotable around a preferably horizontal pivot axis into a mixing position, in which the materials are brought together with a mixing tool. At least the discharge area and/or the closing flap of the mixing tank are located outside the bulk of material. At least one the hole is provided in the discharge area and/or within the closing flap, which is sealed with a correspondingly fitted disk and/or shaft via the intermediary of a membrane with an elastic sealing lip.

The elastic sealing lip may be dimensioned such that when a certain, relatively low overpressure is reached in the mixing tank, it separates from its contact with the disk and/or the shaft to the extent that the gaseous medium, especially air, can flow from the mixing tank into the environment. The hole is preferably arranged centrally in the closing flap or is uniformly distributed over the circumference of the discharge area, so that the bulk of the material within the mixing tank does not reach the area of this hole during the mixing operation. The materials shall remain below this area to possibly prevent any particles from reaching the area of this pressure relief system. The disk and/or the shaft is held centrally in the hole by a simple bracket, which can preferably be screwed on the discharge area or the closing flap from the outside. To clean the pressure relief system, the fastening screws for the bracket can be loosened in a simple manner and the disk and/or the shaft and the ring-shaped membrane, surrounding same, can be removed.

The membrane can be advantageously held by a cover, which can be connected to the closing flap and/or the discharge area and keeps free an annular gap for the escaping air between the disk and/or the shaft. On the inside of the container, the membrane is arranged with the sealing lip that is in contact with the disk and/or the shaft. With its inner edge, the sealing lip is elastically in contact with the cylindrical outer surface of the disk or shaft and springs to the outside in case of a corresponding overpressure in the mixing tank, so that the air can flow to the outside between the sealing lip and the outer surface and subsequently through the annular gap between the cover ring and the outer surface.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is the synoptic view of a container mixer;

FIG. 2 is plan view of the closing flap 8;

FIG. 3 is an enlarged sectional view along line I-I of FIG. 2;

FIG. 4 is an enlarged detailed view for FIG. 3 with the sealing lip 16 closed; and

FIG. 5 is an enlarged detailed view for FIG. 3 with the sealing lip “opened.”

### DESCRIPTION OF THE PREFERRED EMBODIMENTS

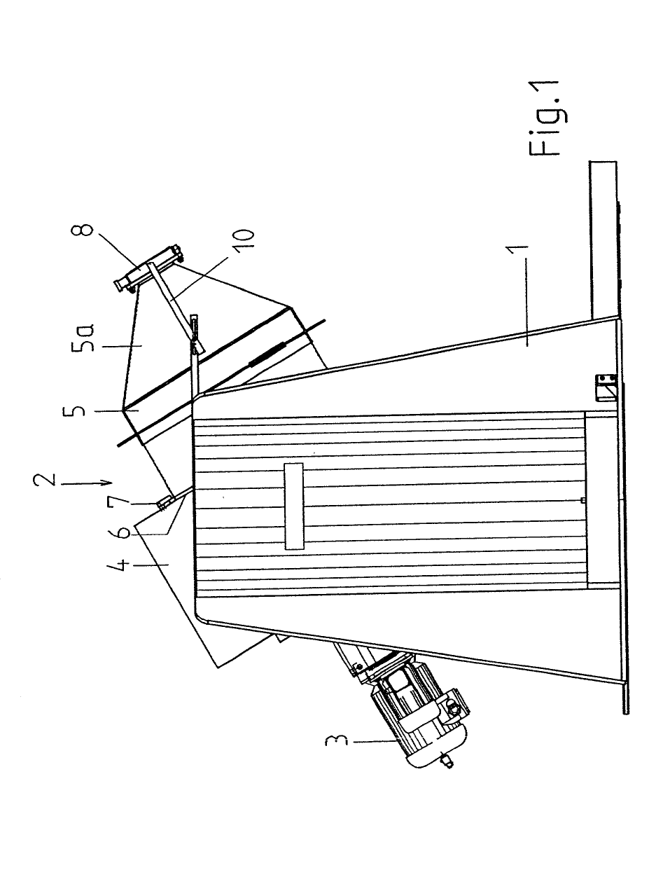

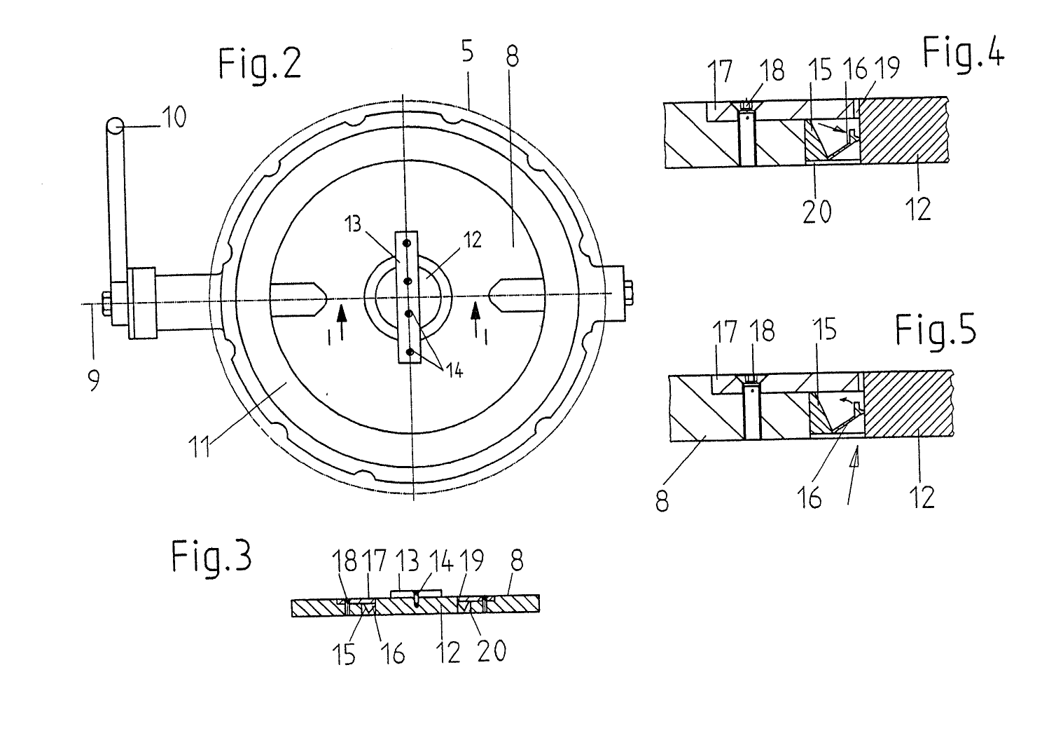

Referring to the drawings in particular, the mixing tank 2 is arranged pivotably on a stationary stand 1 and can be pivoted via a horizontal pivot axis, not shown, from a vertical position into a mixer position shown in FIG. 1 for loading and unloading. In the mixer position according to FIG. 1, the longitudinal axis of the mixer tank is arranged sloped at an angle of about 45° in such a way that the closing flap 8 is located in the highest position. The mixer tank 2 comprises the upper mixer half 4 and the lower mixer half 5 designed as a replaceable container. The upper mixer half 4 is connected to the stand 1 in an articulated manner. The two halves are connected to one another in a gas-tight manner for the mixing operation by means of a clamping device 7 and an intermediate seal 6. The mixing tank 2 is rotated with the drive 3 around its longitudinal axis for the mixing operation. The drives for the mixing tools and for the pivoting operation are not shown. The closing flap 8, shown in greater detail in FIG. 2, is arranged at the narrowest point of the discharge area 5a of the lower mixer half 5. This closing flap 8 is pivotable with an actuating lever 10 around an axis of rotation 9 and has an outer sealing ring 11 for sealing against the discharge area 5a of the mixing tank 2. The pressure relief system according to the present invention is arranged centrally in the closing flap 8 and comprises a short, preferably disk-shaped shaft 12, whose longitudinal axis is identical to the longitudinal axis of the mixer tank 2. A bracket 13, which is detachably connected to the closing flap 8 by means of the fastening screws 14 and is located centrally in a hole 20 of the closing flap 8, is fastened to the shaft 12 on the outside. The internal diameter of the hole 20 is larger than the external diameter of the shaft 12, and the intermediate space is closed with the membrane 15, which is pressed into the hole 20 in a non-positive manner and is elastically in contact with the sealing lip 16 on the outer diameter of the shaft 12. The membrane 15 is held in its position in the closing flap 8 by means of a cover ring 17, which is fastened to the closing flap 8 with fastening screws 18. The internal diameter of the cover ring 17 is larger than the external diameter of the shaft 12, so that an annular gap 19, through which the air escaping from the container can reach the environment, is formed there.

A plurality of holes 20 may be uniformly distributed with respect to a circumference of the discharge area (5a). The form of the holes 20 and the sealing may be as described above.

While specific embodiments of the invention have been shown and described in detail to illustrate the application of the principles of the invention, it will be understood that the invention may be embodied otherwise without departing from such principles.

### Appendix

### LIST OF REFERENCE NUMBERS

| | |
|---|---|
| 1 | Stand (stationary) |
| 2 | Mixing tank (with horizontal pivot axis; rotating around its axis of |
| | rotation) |
| 3 | Drives for 4 and 5 |
| 4 | Upper half of mixer (cylindrical; connected to 1 in an articulated |
| | manner; rotating around the longitudinal axis) |
| 5 | Lower half of mixer (replaceable container) |
| 5a | Discharge area of 5 (conical) |
| 6 | Seal between 4 and 5 |
| 7 | Clamping device on 4 for 5, 6 |
| 8 | Closing flap (in the discharge of 5; pivotable around 9) |
| 9 | Axis of rotation of 8 |
| 10 | Actuating lever for 8 |
| 11 | Outer sealing ring of 8 |
| 12 | Shaft (longitudinal axis identical to longitudinal axis of 2, 4, 5) |
| 13 | Bracket for 12 on 8 |
| 14 | Fastening screws for 13 on 8 and 12 |
| 15 | Membrane between 8 and 12 (made of an elastic material) |
| 16 | Sealing lip of 15 |
| 17 | Cover |
| 18 | Fastening screw for 17 to 8 |
| 19 | Annular gap between 12 and 17 |
| 20 | Hole in 8 for receiving 12 and 15 |

What is claimed is:

1. A pressure relief system for mixing tanks at least temporarily under overpressure, including cylindrical container mixers for powdered, grit-like and/or granular materials, wherein the mixing tank is pivotable around a substantially horizontal pivot axis into a mixing position, in which the materials are brought together with a mixing tool, and wherein at least a discharge area and/or a closing flap of the mixing tank are located outside the bulk of material, the pressure relief system comprising:
at least one the hole;
a membrane with an elastic sealing lip; and
a disk and/or shaft sealing said at least one hole via the intermediary of said membrane with said elastic sealing lip, said at least one hole being arranged in the discharge area and/or within the closing flap for pressure relief during the mixing operation.

2. A pressure relief system in accordance with claim 1, wherein said at least one hole is arranged centrally in the closing flap.

3. A pressure relief system in accordance with claim 1, wherein said at least one hole comprises a plurality of holes uniformly distributed with respect to a circumference of the discharge area.

4. A pressure relief system in accordance with claim 1, further comprising: a bracket detachably connected to the discharge area and/or the closing flap, wherein the disk and/or shaft is held centered in said at least one hole by said bracket.

5. A pressure relief system in accordance with claim 1, further comprising: a bracket detachably connected to the discharge area and/or the closing flap, wherein the disk and/or shaft is held centered in said at least one hole by said bracket.

6. A pressure relief system in accordance with claim 1, wherein said membrane is held by a cover, which can be connected to the closing flap and/or to the discharge area and, the cover for keeping free an annular gap for escaping air between the disk and/or shaft.

7. A pressure relief system in accordance with claim 1, wherein said sealing lip of said membrane is elastically in contact with a cylindrical outer surface of said disk or shaft and springs to the outside in case of a corresponding overpressure in the mixing tank for releasing air.

8. A mixing tank pressure relief system for a mixing tank under at least temporarily overpressure, the mixing tank being pivotable a round a preferably horizontal pivot axis into a mixing position, the mixing tank having a discharge area and/or a closing flap, the pressure relief system comprising:
an opening arranged in the discharge area and/or within the closing flap to provide a passage for pressure relief during the mixing operation;
a membrane with an elastic sealing lip; and
a disk and/or shaft cooperating with said membrane with said elastic sealing lip to seal said opening.

9. A pressure relief system in accordance with claim 8, wherein said opening is arranged centrally in the closing flap.

10. A pressure relief system in accordance with claim 8, further comprising additional openings, said opening and said additional openings being uniformly distributed with respect to a circumference of the discharge area.

11. A pressure relief system in accordance with claim 8, further comprising: a bracket detachably connected to the discharge area and/or the closing flap, wherein the disk and/or shaft is held centered in said opening by said bracket.

12. A pressure relief system in accordance with claim 8, wherein said membrane is held by a cover, which can be connected to the closing flap and/or to the discharge area and, the cover for keeping free an annular gap for escaping air between the disk and/or shaft.

13. A pressure relief system in accordance with claim 8, wherein said sealing lip of said membrane is elastically in contact with a cylindrical outer surface of said disk or shaft and springs to the outside in case of a corresponding overpressure in the mixing tank for releasing air.

14. A mixing tank and pressure relief system combination, the combination comprising:
a mixing tank pivotable around a substantially horizontal pivot axis into a mixing position, said mixing tank having a discharge area and/or a closing flap located outside a region for bulk of material; and
a pressure relief system with an opening arranged in the discharge area and/or within the closing flap for pressure relief during the mixing operation, a membrane with an elastic sealing lip and a disk and/or shaft sealing said opening in cooperation with said membrane with said elastic sealing lip.

15. A combination in accordance with claim 14, wherein said opening is arranged centrally in the closing flap.

16. A combination in accordance with claim 14, further comprising additional openings, said opening and said additional openings being uniformly distributed with respect to a circumference of the discharge area.

17. A combination in accordance with claim 14, further comprising: a bracket detachably connected to the discharge area and/or the closing flap, wherein the disk and/or shaft is held centered in said opening by said bracket.

18. A combination in accordance with claim 14, wherein said membrane is held by a cover, which can be connected to the closing flap and/or to the discharge area and, the cover for keeping free an annular gap for escaping air between the disk and/or shaft.

19. A combination in accordance with claim 14, wherein said sealing lip of said membrane is elastically in contact with a cylindrical outer surface of said disk or shaft and springs to the outside in case of a corresponding overpressure in the mixing tank for releasing air.
